(19) United States
(12) Patent Application Publication
(10) Pub. No.: US 2008/0268308 A1
(43) Pub. Date: Oct. 30, 2008

(54) Fuel Cell Heating Device And Method For Operating Said Fuel Cell Heating Device

(76) Inventors: Lutz Schilling, Stuttgart (DE); Philipp Klose, Hamburg (DE); Christian Hoffmann, Hamburg (DE)

Correspondence Address: VIDAS, ARRETT & STEINKRAUS, P.A., SUITE 400, 6640 SHADY OAK ROAD, EDEN PRAIRIE, MN, 55344, US

(21) Appl. No.: 11/792,786

(22) PCT Filed: Dec. 9, 2005
(86) PCT No.: PCT/EP05/13247

§ 371 Date: Oct. 9, 2007

(30) Foreign Application Priority Data
Dec. 10, 2004 (DE) 10 2004 059 495.3

(51) Int. Cl. H01M 8/06

(52) U.S. Cl. 429/20; 429/17; 48/127.9

(57) ABSTRACT

A fuel cell heating device (10) comprising a gas treatment unit (16) having an inlet line (14) for gas and an outlet line (36) for hydrogenous reformate, wherein the inlet line and the outlet line are linked together by a circulation line in order to re-feed the reformate back to the gas treatment unit, wherein the gas treatment unit has a reformer and a downstream gas purification system comprising an inlet line for air and a water trap.

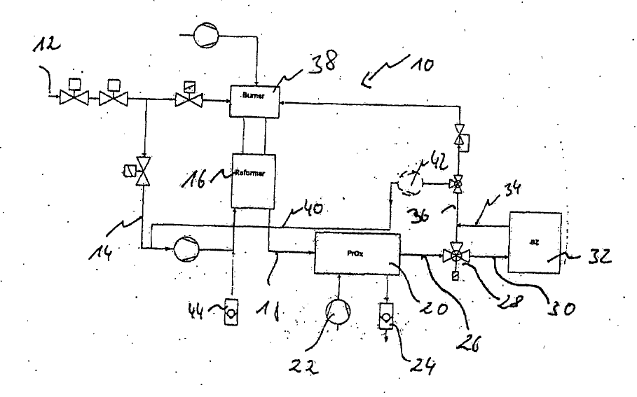

### CROSS-REFERENCE TO RELATED APPLICATIONS

Not applicable

### STATEMENT REGARDING FEDERALLY SPONSORED RESEARCH

Not applicable

The present invention relates to a fuel cell heating device as well as a method for operating said fuel cell heating device, in particular a method for starting up and shutting down a gas treatment unit in the fuel cell heating device.

Fuel cells, such as polymer membrane fuel cells for example, are sufficiently known. Fuel cell heating devices for decentralized energy supply are fed natural gas through a gas supply connection, wherein the hydrogen is reformed from hydrogenous compounds of the natural gas. In a gas treatment unit containing a reformer, the hydrocarbons (CnHm) of the natural gas undergo endothermic reform in the presence of a catalyst by the addition of water vapor, wherein carbon dioxide (CO2) and hydrogen (H2) form. The reformate also contains residues of carbon monoxide (CO), which are selectively oxidized exothermically in a down-stream gas purification by the addition of oxygen. This forms carbon dioxide (CO2) and water (H2O). A gas burner is used for the endothermic steam reformation.

A fuel cell system is known from DE 200 00 857, the entire contents of which is incorporated herein by reference. U1 which has an electrically-actuated three-way valve in a supply line to a fuel cell. The supply line is further provided with a sensor which determines a carbon monoxide concentration in the supply line to the fuel cell. Upon exceeding a predefined threshold for the carbon monoxide, same is prevented from flowing into the fuel cell by the three-way valve being appropriately actuated. The gas will be directed past the fuel cell in a bypass line. The bypassing gas is burned in a burner for the reformer and the evaporator. To further lower the carbon monoxide concentration, it is alternatively likewise possible for the gas to cycle through the arrangement a second time. The second treatment of the gas serves to further lower the carbon monoxide content.

A staged lean combustion for a rapid start of a fuel-processing system is known from DE 102 52 075 A1, the entire contents of which is incorporated herein by reference. For this purpose, two independent burner systems are known. For this purpose, the initial current of the second burner system is supplied to the heat exchanger of a water gas shift reactor/heat exchanger (WGS/HX). The gas is furthered from the heat exchanger as output gas. In so doing, the gas of the second burner is always kept separate from the gas conducted through the shift reactor in die PrOx stage.

Reformation normally ensues at temperatures from 500° C. to 800° C. The reformer catalyst cannot have any contact with oxygen because doing so would damage it or it would become so heavily oxidized that the desired catalytic effect would no longer be obtained. Apart from damage to the reformer caused by oxygen, the reformer can also be damaged or prematurely aged by water condensation.

There is therefore the need to prevent the reformer catalyst from being exposed to an undefined atmosphere and to avoid water vapor from condensing.

For this purpose, it is known to flush the fuel cell heating device with an inert gas, in particular when starting up and shutting down the fuel cell heating device. Nitrogen has preferably been used for this purpose to date, same being pumped into or out of the system from one or more separate reservoirs.

A fuel cell heating device designed to circulate a system gas such as, for example, reformates, anode exhaust gases and/or combustion exhaust gases, through the gas treatment during start-up and shut-down is known from US 2003/0138680. A separate catalytic burner is provided for this purpose across which the circulating gas flow is conducted. In regular operation, no gas flows across the separate catalytic burner, rather the fuel cell is supplied by a regular PrOx stage.

The fuel cell heating device differs from the known fuel cell heating devices in that no additional components are provided for the warm-up and shut-down phases.

It is the technical object of the invention to provide a fuel cell heating device as well as a method for operating said fuel cell heating device which uses the simplest means possible to operate a gas treatment unit in a manner which is safe and gentle on its components.

### BRIEF SUMMARY OF THE INVENTION

The fuel cell heating device according to the invention comprises a gas treatment unit having an inlet line for gas and an outlet line for hydrogenous reformate. Hydrocarbons (CnHm) are converted in the gas treatment unit to carbon dioxide (CO2) and hydrogen (H2) by the addition of water vapor. A circulation line is provided in the fuel cell heating device according to the invention to connect the inlet line and the outlet line. The circulation line enables the initial products of the gas treatment unit to be re-fed back to same, whereby a defined volume of gas circulates in the gas treatment unit. The gas treatment comprises a reformer and a downstream gas purification. The gas purification is hereby preferably provided in the outlet line of the gas treatment unit between the reformer and the valve. The gas fed back via the circulation line has thus been completely cycled through the gas treatment unit. By feeding back the volume of gas to the gas treatment unit, an inert gas can be produced from the reformate by supplying air and separating out water. According to the invention, the circulation line is connected to the outlet line by at least one valve which connects the circulation line with the outlet line of the gas treatment unit. The use of the valve enables the circulatory feed of a volume of gas through the circulation line and thereby cuts off the gas supply to the fuel cell. For this purpose, a three-way valve, a pair of valves or another arrangement of valves can be disposed in the line. In the invention, the gas purification is utilized both in the warm-up phase, in which the reformate circulates, as well as in the regular operational phase, in which the reformate is supplied to the fuel cell.

The gas treatment unit preferably comprises an oxidation unit for the gas purification. Carbon monoxide is converted to carbon dioxide and water in the gas purification by the addition of air. In the gas treatment process, air is likewise supplied to the gas treatment unit.

### DETAILED DESCRIPTION

The fuel cell heating device 10 is fed process gas via a supply line. The process gas is fed to a reformer 16 via the line 14. The reformate from the reformer 16 is supplied to a PrOx stage 20 via a line 18. A supply of air 22 follows in PrOx stage 20 and the water which forms is discharged by a water trap 24. The gas which is formed in the PrOx stage 20 is conveyed by a line 26 through a three-way valve 28 and the three-way valve accordingly set for the fuel cell 32 through line 30.

The gas exiting the fuel cell 32 is fed via a line 34 to a line 36. The line 36 leads into a burner 38 which provides the process heat for the reformer 16. Branching off from the line 36 which forms the outlet line for the gas treatment unit is a circulation line 40 which connects the line 36 with the inlet line 16 for the reformer. The circulation line 40 is closed via a three-way valve 37 on the line 36. The three-way valve 37 allows a volume of gas to circulate, inclusive the fuel cell 32.

A circulation pump 42 can additionally be provided in the circulation line 40 to pump a flow of gas through the circulatory circuit. The circulatory circuit is formed by the line 40 which leads via line 14 into the reformer 16 and via line 18 into the PrOx unit 20, line 26 and the three-way valve 28, and ending at line 36 and the three-way valve 37.

Reformation normally ensues at temperatures from 500° C. to 800° C. Generally speaking, the reformer catalyst cannot have any contact with oxygen in the process because otherwise the oxygen would either damage the catalyst or heavily oxidize it. As long as reformate is produced, the reformer is filled with the process gas, which provides a safe atmosphere. A correspondingly safe atmosphere forms when water 44 is supplied to the reformer 16 as water vapor. It must hereby be ensured that the water does not condense since doing so would likewise lead to damaging or premature aging of the catalyst.

The catalyst is not to be subjected to any undefined atmosphere during operation of the fuel cell heating device and water as well as residual combustible reformate should be removed from the system. In the normal operational state, the system is supplied with process heat via the burner 38. In addition, the reformer 16 is supplied the educts water 44 and hydrocarbon (CnHm), for example from natural gas. At temperatures from 500° C. to 800° C., the natural gas is reformed, essentially forming H2 and CO2. Some percent of residual methane is also contained in the reformate since there is not an absolute conversion of the natural gas. The reformate is moistened since there is more overall water in the system than is necessary for the reformation process.

The reformate also contains CO as an unwanted by-product, which can have a negative impact on the fuel cell operation. In order to remove the CO, the reformate is conveyed to a so-called PrOx stage. CO is preferably converted into CO2 and water there by supplying atmospheric oxygen in the presence of a catalyst. This process is also referred to as preferential oxidation. In a secondary reaction, however, H2 is also converted to water here with O2. Subsequent the PrOx, the CO content has usually been reduced to a few ppm such that the gas can be supplied to the fuel cell.

Upon shutting down the system, thus when the system is switched off or in stand-by mode, the supply of the water and natural gas educts in the reformer is stopped and the supply of process heat ceases. At the same time, the gas flow is rerouted ahead of the fuel cell at the three-way valve 28 and channeled to the circulation line 40. From there it is fed to the supply line 14 for the reformer. Either an educt pump 43 can be used to circulate the gas or also a separate circulation pump 42 integrated into the line 40. Alternatively, both pumps can also be provided.

The remaining reformate is circulated via the circulation line 40 through the gas treatment unit including reformer 16 and the PrOx stage 20. In the process, air is supplied to the PrOx stage 20. The oxygen O2 in the air reacts with the H2 of the circulation gas to water. This water is discharged from the PrOx by a water trap 24. The circulation gas cannot pass through the water trap.

The residual methane within the reformate is further converted in the reformer into H2 and CO2 until a balance is reached and no further residual methane is converted. The supply of the necessary process heat is still long sufficient due to the storage effect of the reformer.

By the continuous circulation in the gas treatment unit and the supply of air from the PrOx, H2 from the reformate is nearly completely converted into H2O. Moreover, the remaining nitrogen accumulates in the circulation gas. After a few minutes, the circulation gas consists essentially only of carbon dioxide (CO2) and nitrogen (N2) as well as small quantities of methane (CH4) and hydrogen (H2).

This atmosphere ensures the necessary protective effect for the reformer catalyst. At the same time, this method also removes excess water from the system, which extends the life of the catalyst.

When starting up the gas treatment unit, there is an inert gas atmosphere of carbon dioxide (CO2) and nitrogen (N2) from the last shut-down cycle as described above. This protects the catalyst of the reformer 16 against unwanted oxidation during the warm-up.

When starting up the system, the inert gas is circulated in the system in the same way as when shutting down. That is to say the inert gas flows back through the circulation line 40 into the reformer. The air supply 22 of the PrOx stage 20 is blocked during start-up.

A positive effect of the circulation during start-up is the attaining of a better distribution of the process heat in the gas treatment unit and the reformer. As soon as the point of water condensation in the reformer is exceeded, the educt water can be supplied to the reformer. At the same time, the circulatory circuit can be opened to the reformer/burner. The developing water vapor now displaces the inert gas from the gas treatment unit and supplies it to the burner. It is thereby also possible to not open the circulatory circuit directly to the burner but rather to conduct the inert gas to the burner through the fuel cell.

During start-up, the burner is supplied with fuel gas, typically natural gas. If the displaced inert gas is now supplied to the burner, a dilution of the necessary combustion air occurs. This is countervailed by operating the burner at a higher air ratio than would be necessary for a clean burn.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A fuel cell heating device (10) comprising a gas treatment unit (16) having an inlet line (14) for gas and an outlet line (36) for hydrogenous reformate,
characterized in that
the inlet line (14) and the outlet line (36) are linked together by a circulation line (40) in order to re-feed the reformate back to the gas treatment unit (16), wherein the gas treatment unit has a reformer (16) and a downstream gas purification system (20) comprising an inlet line for air (22) and a water trap (24).

2. The fuel cell heating device according to claim 1, characterized in that the circulation line (40) is connected to the outlet line (36) by means of at least one valve (28, 37) which connects a supply line (30) for a fuel cell with the outlet line (36) of the gas treatment unit.

3. The fuel cell heating device according to claim 1 or 2, characterized in that the outlet line (26) of the gas treatment unit is arranged between the reformer (16) and the valve (28) and the gas purification (20) for processing reformate.

4. The fuel cell heating device according to claim 3, characterized in that an oxidation unit (20) is provided as the gas purification system.

5. The fuel cell heating device according to any one of claims 2 to 4, characterized in that the valve (28, 37) is set such that a gas from the gas treatment unit is again re-fed back through same.

6. The fuel cell heating device according to any one of claims 1 to 5, characterized in that air (22) is supplied to the gas treatment unit.

7. A method for operating a fuel cell heating device exhibiting the following:
a volume of gas ciculating in a gas treatment unit during the start-up and shut-down of the gas treatment unit, wherein the gas from the outlet line of the gas treatment unit is supplied to the inlet line of the gas treatment unit.

8. The method according to claim 7, characterized in that reformate is circulated in the gas treatment unit when shutting down the gas treatment system upon the application of air until an inert gas has formed in the gas treatment unit.

9. The method according to claim 8, characterized in that the water forming with the air supply is discharged.

10. The method according to claim 8 or 9, characterized in that a conversion of the circulating reformate occurs during shut-down until a balance is reached in the composition of the gas.

11. The method according to claim 10, characterized in that the inert gas essentially consists of carbon dioxide and nitrogen.

12. The method according to any one of claims 7 to 11, characterized in that an inert gas circulates in the gas treatment system upon application of heat when starting up said gas treatment system.

13. The method according to claim 12, characterized in that water is supplied upon a predetermined temperature being reached in the gas treatment system.

14. The method according to claim 13, characterized in that the outlet line of the gas treatment unit is opened to a supply line to the burner after the water has been supplied.

15. The method according to claim 13, characterized in that the outlet line of the gas treatment unit is opened to a supply line to a fuel cell after the water has been supplied.
